(19) United States
(12) Patent Application Publication
(10) Pub. No.: US 2012/0096459 A1
(43) Pub. Date: Apr. 19, 2012

(54) METHOD OF MIGRATING VIRTUAL MACHINE

(75) Inventor: Keiji MIYAZAKI, Kawasaki (JP)

(73) Assignee: FUJITSU LIMITED, Kawasaki-shi (JP)

(21) Appl. No.: 13/221,273

(22) Filed: Aug. 30, 2011

(30) Foreign Application Priority Data
Oct. 18, 2010 (JP) 2010-233999

(51) Int. Cl. G06F 15/173; G06F 9/455

(52) U.S. Cl. 718/1; 709/226

(57) ABSTRACT

A method of migrating a virtual machine from a first computer to a second computer includes: performing an external communication of the virtual machine via a first buffer before starting migration of the virtual machine, performing an external communication of the virtual machine via a second buffer different from the first buffer during the migration, starting the migration upon receiving a request for migrating the virtual machine, storing information destined for the virtual machine in the second buffer upon receiving the information during the migration, and transferring the information stored in the second buffer to the second computer in response to termination of the virtual machine.

### CROSS-REFERENCE TO RELATED APPLICATION

This application is based upon and claims the benefit of priority of the prior Japanese Patent Application No. 2010-233999, filed on Oct. 18, 2010, the entire contents of which are incorporated herein by reference.

### FIELD

The embodiments discussed herein are related to a method of migrating a virtual machine.

### BACKGROUND

In a system in which multiple servers are connected over a network, a virtual machine running on a source server may be migrated to a destination server. In the migration of a virtual machine, the content of a memory in the source server, which is used by the virtual machine to be migrated, is transferred to a memory in the destination server. The process in the virtual machine to be migrated is ongoing even during the transfer of the content of the memory in the source server to the memory in the destination server. The virtual machine to be migrated is terminated, for example, when the amount of content of the memory which is not yet transferred is smaller than or equal to a predetermined value. When all the content of the memory in the source server has been transferred to the memory in the destination server, the destination server runs the virtual machine by using the content of the memory in the destination server.

Japanese Laid-open Patent Publication No. 2004-153542 discloses a related technique.

### SUMMARY

According an aspect of the present invention, provided is a method of migrating a virtual machine from a first computer to a second computer. The method includes: performing an external communication of the virtual machine via a first buffer before starting migration of the virtual machine, performing an external communication of the virtual machine via a second buffer different from the first buffer during the migration, starting the migration upon receiving a request for migrating the virtual machine, storing information destined for the virtual machine in the second buffer upon receiving the information during the migration, and transferring the information stored in the second buffer to the second computer in response to termination of the virtual machine.

The object and advantages of the invention will be realized and attained by means of the elements and combinations particularly pointed out in the claims. It is to be understood that both the foregoing general discussion and the following detailed discussion are exemplary and explanatory and are not restrictive of the invention, as claimed.

### BRIEF DESCRIPTION OF DRAWINGS

FIG. 1 is a diagram illustrating an exemplary system in which multiple servers are connected to each other over a network;

FIG. 2 is a diagram illustrating an exemplary hardware configuration of a server;

FIG. 3 is a diagram illustrating an exemplary functional configuration of a source server according to an embodiment of the present invention;

FIG. 4 is a diagram illustrating an exemplary operation flow of a source server upon receiving a VM migration request for migrating a virtual machine running on the source server according to an embodiment of the present invention;

FIG. 5 is a diagram illustrating an exemplary operation flow of a virtual switch in a source server according to an embodiment of the present invention;

FIG. 6 is a diagram illustrating an exemplary operation flow of a virtual switch in a source server upon receiving a packet acquisition request from a virtual machine according to an embodiment of the present invention;

FIG. 7 is a diagram illustrating an exemplary operation flow of a virtual switch in a source server upon receiving a packet from a virtual machine according to an embodiment of the present invention;

FIG. 8 is a diagram illustrating an exemplary operation flow of a virtual switch upon detecting termination of a virtual machine running on a source server according to an embodiment of the present invention;

FIG. 9 is a diagram illustrating an exemplary functional configuration of a destination server according to an embodiment of the present invention;

FIG. 10 is a diagram illustrating an exemplary operation flow of a virtual switch in a destination server upon detecting migration of a virtual machine according to an embodiment of the present invention;

FIG. 11 is a diagram illustrating an exemplary operation flow of a virtual switch in a destination server for receiving contents of migration buffer according to an embodiment of the present invention;

FIG. 12 is a diagram illustrating an exemplary operation flow of a virtual switch in a destination server upon receiving a packet acquisition request from a virtual machine according to an embodiment of the present invention;

FIG. 13 is a diagram illustrating an exemplary operation flow of a virtual switch in a destination server upon receiving a packet from a virtual machine according to an embodiment of the present invention; and

FIG. 14 is a diagram illustrating exemplary access from a virtual machine to a PCI Express device according to an embodiment of the present invention.

### DESCRIPTION OF EMBODIMENTS

In the migration of the virtual machine, a hypervisor in the source server causes the source server to discard all the packets received after the virtual machine is terminated. Even after the virtual machine is migrated to the destination server, packets are continued to be transferred to the source server until the network configuration is changed to update the communication path for the virtual machine after the migration, to be destined for the destination server. Accordingly, the hypervisor in the source server causes the source server to discard all the packets received after the virtual machine is terminated until the network configuration is changed to update the communication path for the virtual machine after the migration, to be destined for the destination server.

Thus, there is such a problem in conventional migration of a virtual machine that packets are discarded because the packets are continued to be transmitted to the source server which has been running the virtual machine after the virtual machine is terminated in the source server until the network configuration is changed to update the communication path for the virtual machine in the destination server.

Accordingly, it is preferable to provide such a method of migrating a virtual machine that is capable of preventing packets transmitted or received by a virtual machine from being discarded during the migration of the virtual machine.

According to the embodiments, it is possible to prevent packets transmitted or received by a virtual machine from being discarded during the migration of the virtual machine.

According to the embodiments, during the migration of a virtual machine running on a physical machine (or a computer), a hypervisor in a source or destination physical machine causes the source or destination physical machine to create a migration buffer to perform external communication of the virtual machine via the migration buffer. The source physical machine starts to transfer information destined for the virtual machine, which is received during the migration and stored in the migration buffer, to the destination physical machine after the virtual machine is terminated in order to migrate the virtual machine running on the source physical machine. The information transmitted to the virtual machine which has been running on the source physical machine is transferred to the destination physical machine and stored in the migration buffer created in the destination physical machine until the network configuration is changed to update the communication path for the virtual machine after the migration, to be destined for the destination physical machine. Thus, the information, which is transmitted during the migration of the virtual machine, destined for the migrated virtual machine is prevented from being discarded.

The method of migrating a virtual machine will be discussed with reference to the attached drawings.

### Embodiments

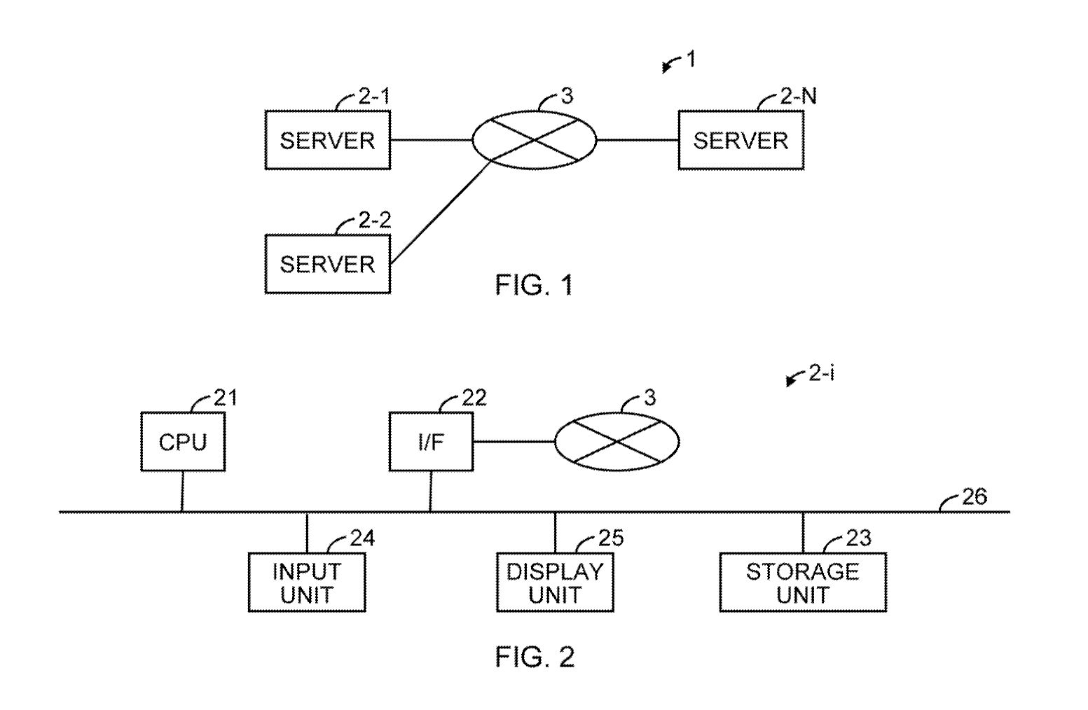

FIG. 1 illustrates an exemplary system in which multiple servers are connected to each other over a network. A system 1 illustrated in FIG. 1 has a configuration in which multiple servers 2-1 to 2-N (N is a natural number that is larger than one) are connected to each other over a network 3. Each of the servers 2-1 to 2-N may be a physical machine, such as a general-purpose computer, having a known configuration including a processor, a storage unit, and so on. The network 3 may be a wired network, a wireless network, or a combination of a wired network and a wireless network.

FIG. 2 illustrates an exemplary hardware configuration of a server. Referring to FIG. 2, a server 2-i (i=1 to N) has a configuration in which a central processing unit (CPU) 21, an interface (I/F) 22, a storage unit 23, an input unit 24 including a keyboard, a mouse, etc., and a display unit 25 are connected to each other via a bus 26. The CPU 21 controls the entire server 2-i. A hypervisor causes the CPU 21 to create a virtual machine. In other words, the virtual machine runs on the server 2-i. The I/F 22 outputs a command (a request) or data transmitted from the server 2-i to the network 3 and inputs a command or data received over the network 3 into the server 2-i. The storage unit 23 stores various programs including the hypervisor executed by the CPU 21 and a variety of data including intermediate data in arithmetic operations executed by the CPU 21. The input unit 24 is used to input various commands or data into the CPU 21. The display unit 25 is used to display a screen image prompting a user to perform an operation, results of calculation executed by the CPU 21, and so on.

The storage unit 23 may be a computer-readable recording medium. The computer-readable recording medium is, for example, a magnetic recording medium, an optical recording medium, a magneto-optical recording medium, a disk apparatus using a disk as the recording medium, or a semiconductor storage device such as a random access memory (RAM) and a read only memory (ROM).

The servers 2-1 to 2-N may not necessarily have the same hardware configuration. A multiprocessor configuration including multiple CPUs that are connected in parallel may be adopted in the part corresponding to the CPU 21 in FIG. 2.

In an embodiment, the hypervisor in a source or destination server causes the CPU 21 to create an input-output buffer (migration buffer), which includes an input buffer and an output buffer, for virtual machine (VM) migration. Upon receiving a VM migration request for migrating the virtual machine, the virtual machine performs external communication via the created input-output buffer for VM migration.

A process of inputting information into a virtual machine is performed, for example, in the following manner. The source server starts, in response to termination of the virtual machine, to transfer information stored in the input buffer (referred to as a migration input buffer) for VM migration to the destination server, that information has been received after receiving the VM migration request for migrating the virtual machine. The source server keeps the migration input buffer and transfers the received information to the destination server until the source server receives a migration completion notification from the virtual machine which is migrated to the destination server, and finally transmits a transfer termination notification to the destination server. In contrast, the destination server stores, in the migration input buffer thereof, information transmitted from the migration input buffer created in the source server. The destination server starts, in response to startup or restart of the migrated virtual machine, to transfer the information stored in the migration input buffer to the virtual machine until the destination server receives the transfer termination notification. The destination server uses an ordinary input buffer after the destination server has received the transfer termination notification.

A process of outputting information from a virtual machine is performed, for example, in the following manner. The source server stores, upon receiving the VM migration request for migrating the virtual machine, information received from the virtual machine in the output buffer (referred to as a migration output buffer) for VM migration to perform an external communication of the virtual machine. The source server starts, in response to termination of the virtual machine, to transfer the information stored in the migration output buffer to the destination server. When no incomplete information is stored in the migration output buffer created in the source server, the source server transmits a notification (or a message) indicating the absence of incomplete information to the destination server. The destination server stores, in the migration output buffer thereof, the information transferred from the migration output buffer created in the source server. The destination server transmits complete information (for example, a packet) composed of part of the information transmitted from the virtual machine after the virtual machine is started up and the information stored in the migration output buffer to the outside of the destination server. Upon receiving a notification indicating the absence of incomplete information, the destination server uses the ordinary output buffer, instead of the migration output butter.

With the above configuration, it is possible to eliminate the disadvantage of an occurrence of discard (for example, packet loss) of information from/to the virtual machine during the migration of the virtual machine. Since the migration of the virtual machine may be realized even in, for example, a mission critical operation, the application range of the virtual machine may be extended.

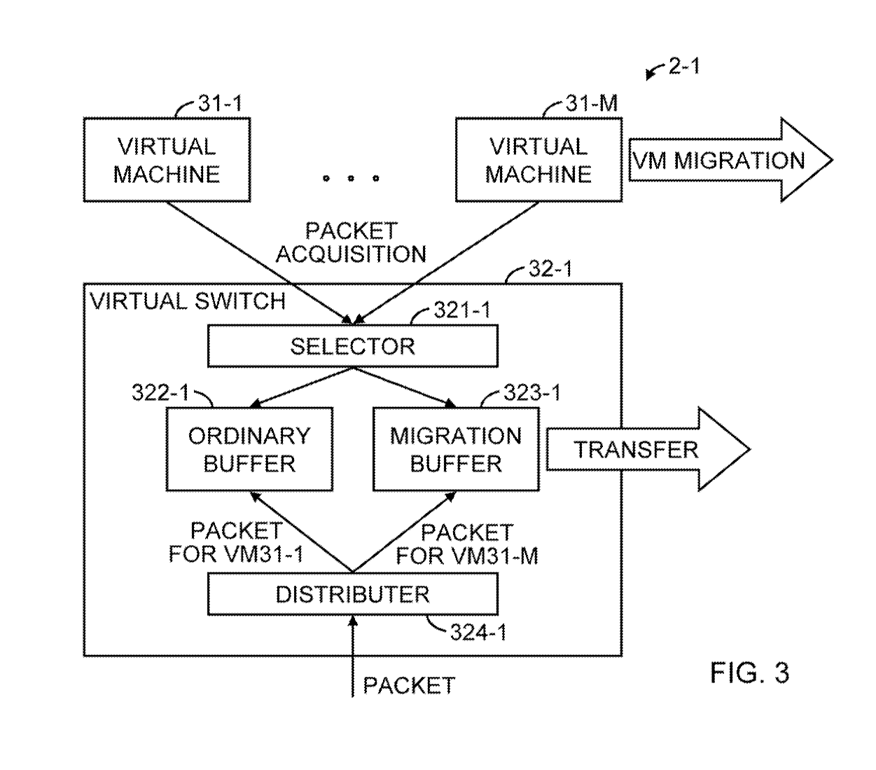

FIG. 3 illustrates an exemplary functional configuration of a source server according to the present embodiment. For convenience, it is assumed that the server 2-1 is the source server and the server 2-2 discussed below is the destination server. Referring to FIG. 3, the source server 2-1 includes virtual machines 31-1 to 31-M (M is a natural number that is larger than or equal to one) and a virtual switch (SW) 32-1. The hypervisor in the source server 2-1 causes the CPU 21 of the source server 2-1 to create and control each of the virtual machines 31-1 to 31-M and the virtual switch 32-1. The virtual switch 32-1 includes a selector 321-1, an ordinary buffer 322-1, a migration buffer 323-1, and a distributor 324-1. Switching software causes the CPU 21 to switch the packets. The selector 321-1 selectively outputs information from the virtual machines 31-1 to 31-M to the ordinary buffer 322-1 or the migration buffer 323-1. The distributor 324-1 selectively outputs information received over the network 3 to the ordinary buffer 322-1 or the migration buffer 323-1. The ordinary buffer 322-1 includes an ordinary reception buffer and an ordinary transmission buffer. The migration buffer 323-1 includes a migration reception buffer and a migration transmission buffer. Each of the ordinary buffer 322-1 and the migration buffer 323-1 is an input-output buffer including an input buffer (a reception buffer) and an output buffer (a transmission buffer).

It is assumed that the memory contents stored in the storage unit 23 for creating the virtual machines 31-1 to 31-M and data transferred from/to the virtual machines 31-1 to 31-M are transferred within the server 2-1 and between the server 2-1 and the server 2-2 in a form of a packet.

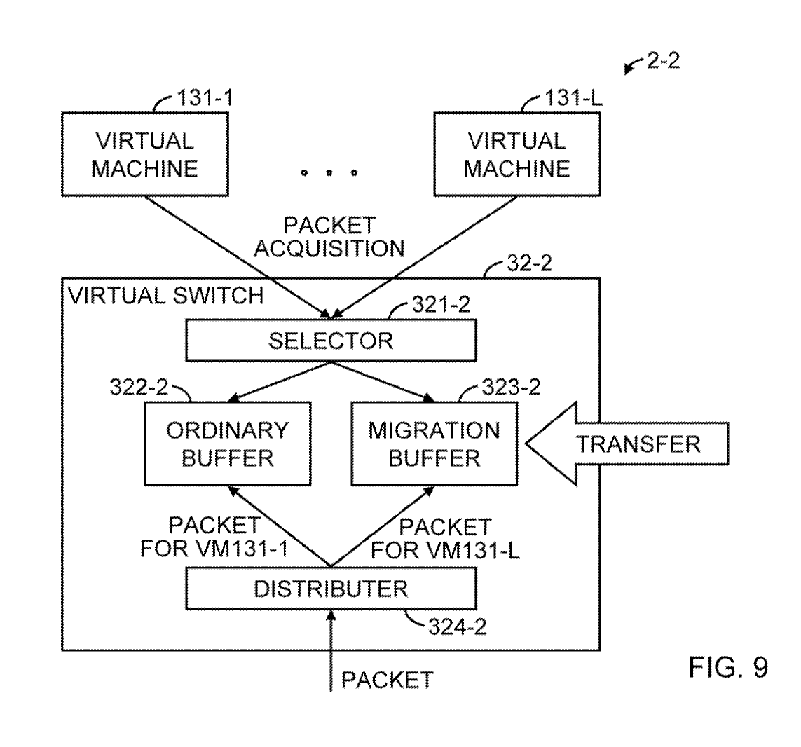

The destination server has a similar configuration as that of the source server, as discussed below with reference to FIG. 9.

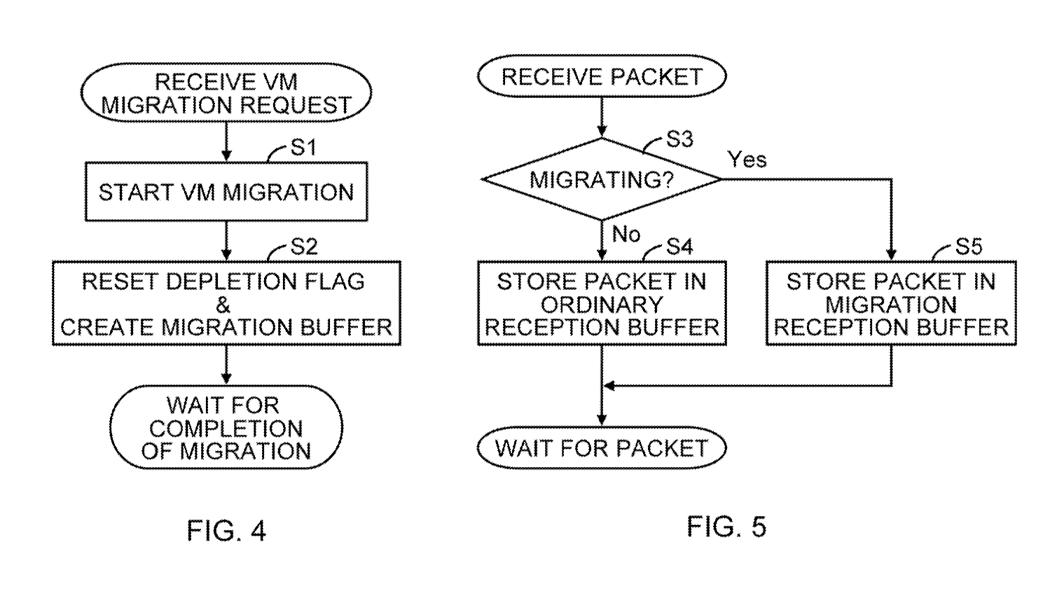

FIG. 4 illustrates an exemplary operation flow of the source server 2-1 upon receiving a VM migration request for migrating the virtual machine 31-1 according to the present embodiment. The source server 2-1 starts the operation flow illustrated in FIG. 4 upon receiving, via the input unit 24, a VM migration request for migrating the virtual machine 31-1.

In S1, the source server 2-1 starts a VM migration process.

In S2, the source server 2-1 resets an ordinary buffer depletion flag to “OFF”. The ordinary buffer depletion flag, when the value thereof is “ON”, indicates that the ordinary buffer (a first buffer) 322-1 has no data destined for the virtual machine to be migrated. The hypervisor in the source server 2-1 causes the CPU 21 to create the migration buffer (a second buffer) 323-1 in the storage unit 23. Thereafter, the source server 2-1 gets into a state of waiting for completion of VM migration in which the source server 2-1 waits for completion of the VM migration process.

The virtual machine performs communications via the ordinary reception buffer and the ordinary transmission buffer included in the ordinary buffer 322-1 while the source server 2-1 performs ordinary operations without migrating the virtual machine. Upon receiving the VM migration request, the source server 2-1 starts the VM migration process and creates, for the virtual machine to be migrated, the migration buffer 323-1 including the migration transmission buffer and the migration reception buffer in the storage unit 23 included in the server 2-1.

FIG. 5 illustrates an exemplary operation flow of the virtual switch 32-1 in the source server 2-1 according to the present embodiment. The virtual switch 32-1 starts the operation flow illustrated in FIG. 5 upon receiving a packet over the network 3.

In S3, the virtual switch 32-1 determines whether the destination of the received packet is the virtual machine 31-1 that is being migrated.

In S4, when the destination of the received packet is not the virtual machine 31-1 that is being migrated (“No” in S3), the virtual switch 32-1 controls the distributor 324-1 so as to store the received packet in the ordinary reception buffer included in the ordinary buffer 322-1.

In S5, when the destination of the received packet is the virtual machine 31-1 that is being migrated (“Yes” in S3), the virtual switch 32-1 controls the distributor 324-1 so as to store the received packet in the migration reception buffer included in the migration buffer 323-1. After S4 or S5, the virtual switch 32-1 gets into a state of waiting for receiving a packet in which the virtual switch 32-1 waits for receiving a packet over the network 3.

As discussed above, the virtual switch 32-1 that has received a packet destined for a virtual machine controls the distributor 324-1 so as to store the received packet in the migration buffer 323-1 when the destination virtual machine of the packet is being migrated, and so as to store the packet in the ordinary buffer 322-1 when the destination virtual machine is not being migrated.

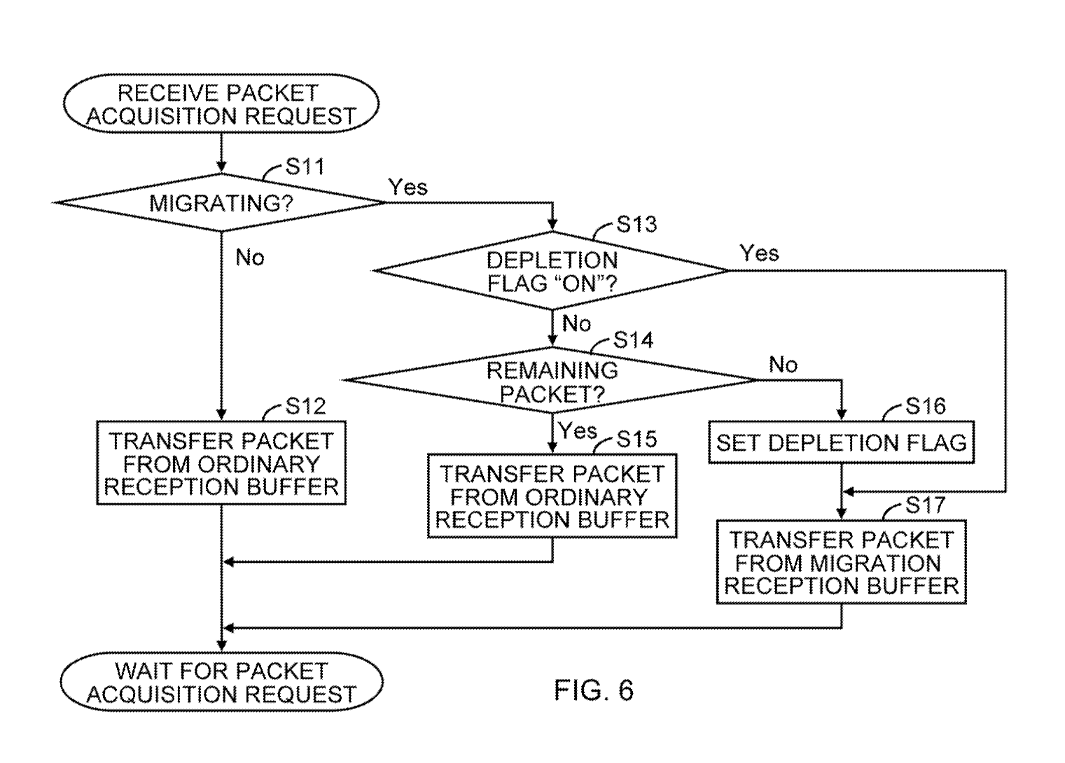

FIG. 6 illustrates an exemplary operation flow of the virtual switch 32-1 in the source server 2-1 upon receiving a packet acquisition request from a virtual machine according to the present embodiment. The virtual switch 32-1 starts the operation flow illustrated in FIG. 6 upon receiving a packet acquisition request from any of the virtual machines 31-1 to 31-M.

In S11, the virtual switch 32-1 determines whether the virtual machine (hereinafter referred to as a request source VM) which has submitted the packet acquisition request for acquiring a packet destined for the request source VM is being migrated.

In S12, when the request source VM is not being migrated, for example, the request source VM is the virtual machine 31-M (“No” in S11), the virtual switch 32-1 acquires a packet stored in the ordinary reception buffer included in the ordinary buffer 322-1 and transfers the acquired packet to the request source VM 31-M via the selector 321-1. When the request source VM is being migrated, for example, the request source VM is the virtual machine 31-1 (“Yes” in S11), the virtual switch 32-1 advances the process to S13.

In S13, the virtual switch 32-1 determines whether the ordinary buffer depletion flag is set to “ON”. When the ordinary buffer depletion flag is set to “ON” (“Yes” in S13), the virtual switch 32-1 advances the process to S17 discussed below.

In S14, when the ordinary buffer depletion flag is reset to “OFF” (“No” in S13), the virtual switch 32-1 determines whether a packet destined for the request source VM 31-1 remains in the ordinary reception buffer included in the ordinary buffer 322-1.

In S15, when a packet destined for the request source VM 31-1 remains in the ordinary reception buffer included in the ordinary buffer 322-1 (“Yes” in S14), the virtual switch 32-1 acquires the remaining packet in the ordinary reception buffer included in the ordinary buffer 322-1 and transfers the acquired packet to the request source VM 31-1 via the selector 321-1.

In S16, when no packet destined for the request source VM 31-1 remains in the ordinary reception buffer included in the ordinary buffer 322-1 (“No” in S14), the virtual switch 32-1 sets the ordinary buffer depletion flag to “ON” and advances the process to S17.

In S17, the virtual switch 32-1 acquires a packet stored in the migration reception buffer included in the migration buffer 323-1 and transfers the acquired packet to the request source VM 31-1 via the selector 321-1. After S12, S15, or S17, the virtual switch 32-1 gets into a state of waiting for receiving a packet acquisition request in which the virtual switch 32-1 waits for receiving a packet acquisition request from a virtual machine.

As discussed above, the virtual switch 32-1 that has received a packet acquisition request from a virtual machine reads out a packet from the ordinary buffer 322-1 when the request source VM is not being migrated. When the request source VM is being migrated, the virtual switch 32-1 checks whether a packet destined for the request source VM remains in the ordinary buffer 322-1. When a packet destined for the request source VM remains in the ordinary buffer 322-1, the virtual switch 32-1 reads out the remaining packet from the ordinary buffer 322-1. When no packet destined for the request source VM remains in the ordinary buffer 322-1, the virtual switch 32-1 sets the ordinary buffer depletion flag to “ON” and thereafter acquires a packet from the migration buffer 323-1.

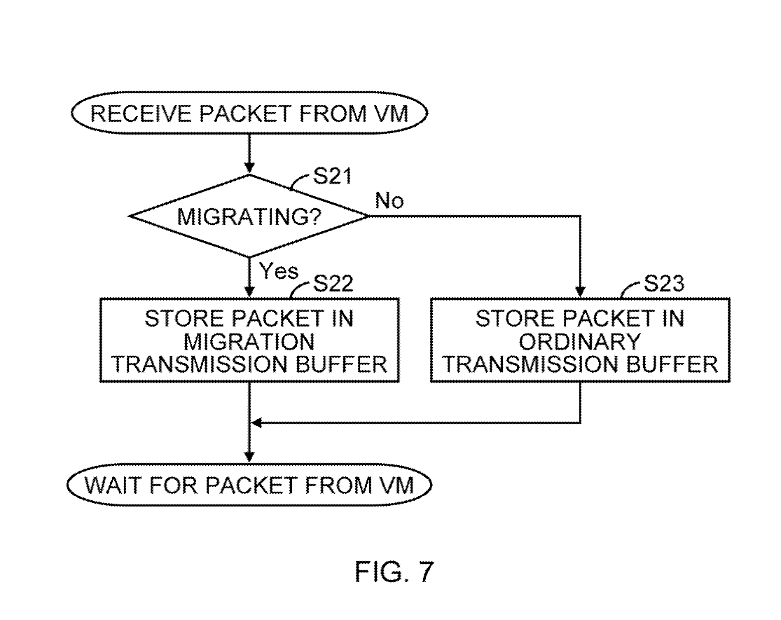

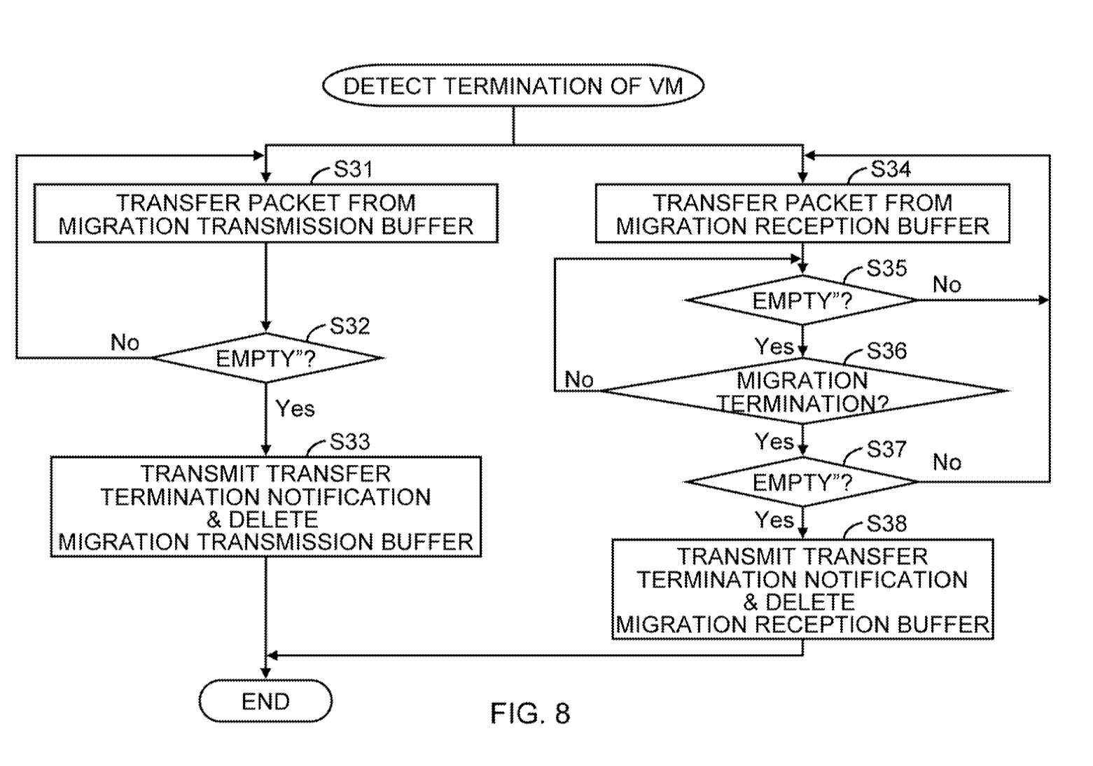

FIG. 7 illustrates an exemplary operation flow of the virtual switch 32-1 in the source server 2-1 upon receiving a packet from a virtual machine according to the present embodiment. The virtual switch 32-1 starts the operation flow illustrated in FIG. 7 upon receiving a packet from a virtual machine.

In S21, the virtual switch 32-1 determines whether the virtual machine (hereinafter referred to as a transmission source VM) which has transmitted the packet is being migrated.

In S22, when the transmission source VM is being migrated, for example, the transmission source VM is the virtual machine 31-1 (“Yes” in S21), the virtual switch 32-1 controls the selector 321-1 so as to store the received packet in the migration transmission buffer included in the migration buffer 323-1.

In S23, when the transmission source VM is not being migrated, for example, the transmission source VM is the virtual machine 31-M (“No” in S21), the virtual switch 32-1 controls the selector 321-1 so as to store the received packet in the ordinary transmission buffer included in the ordinary buffer 322-1.

After S22 or S23, the virtual switch 32-1 gets into a state of waiting for receiving a packet in which the virtual switch 32-1 waits for receiving a packet from a virtual machine.

As discussed above, also in the transmission of a packet from a virtual machine, as illustrated in FIG. 7, the virtual switch 32-1 stores a packet received from a virtual machine that is being migrated in the migration transmission buffer included in the migration buffer 323-1, and stores a packet received from a virtual machine that is not being migrated in the ordinary transmission buffer included in the ordinary buffer 322-1. The virtual switch 32-1 transmits the packet received from the virtual machine to a destination outside the source server 2-1 (to the network 3 in this example).

FIG. 8 illustrates an exemplary operation flow of the virtual switch 32-1 upon detecting termination of a virtual machine running on the source server 2-1 according to the present embodiment. Even when the stored content (that is, a packet) of the migration buffer 323-1 in the source server 2-1 is being transferred to a migration buffer created in the destination server 2-2, the process of the virtual machine 31-1 to be migrated is continued. The source server 2-1 terminates the virtual machine 31-1 to be migrated when, for example, the amount of contents (that is, the amount of packets) in the migration buffer 323-1 that is not yet transferred is smaller than or equal to a predetermined value. The predetermined value may be equal to zero. The virtual switch 32-1 starts the operation flow illustrated in FIG. 8 upon detecting termination of the virtual machine 31-1. Referring to FIG. 8, S31 may be performed concurrently with S34.

In S31, the virtual switch 32-1 transfers a packet stored in the migration transmission buffer included in the migration buffer 323-1 to the destination server 2-2 along with information (for example, a universally unique identifier (UUID) or a media access control (MAC) address) for identifying the virtual machine 31-1 to be migrated.

In S32, the virtual switch 32-1 determines whether the migration transmission buffer included in the migration buffer 323-1 is empty. When the migration transmission buffer included in the migration buffer 323-1 is not empty (“No” in S32), the virtual switch 32-1 returns the process to S31.

In S33, when the migration transmission buffer included in the migration buffer 323-1 is empty (“Yes” in S32), the virtual switch 32-1 transmits a transfer termination notification, which indicates that the transfer from the migration transmission buffer is terminated, to the destination server 2-2 and deletes the migration transmission buffer included in the migration buffer 323-1. The deletion of the migration transmission buffer means that the entire stored content of the migration transmission buffer is deleted or that the migration transmission buffer itself included in the migration buffer 323-1 is deleted.

The transfer time is varied depending on the storage capacity of the migration buffer 323-1 (or the ordinary buffer 322-1). For example, when the storage capacity is equal to 1 GB and the transfer speed is equal to 1 Gbps, it may take at least about 10 seconds to transfer the content of the migration buffer 323-1 (or the ordinary buffer 322-1) to the destination server 2-2. The process of the virtual machine 31-1 is taken over by a virtual machine 131-1 (discussed later), which is a successor of the virtual machine 31-1 as a result of the migration, running on the destination server 2-2 and may be continued even while the content of the migration buffer 323-1 is being transferred to the destination server 2-2. However, the process of the virtual machine 131-1 (that is, the process of virtual machine 31-1) may be suspended, for example, for about one second between the termination of the virtual machine 31-1 running on the source server 2-1 and the start of the virtual machine 131-1 on the destination server 2-2 as the restart of the virtual machine 31-1. Furthermore, it may take, for example, a few tens of seconds to update the communication path for the virtual machine 131-1 due to the migration of the virtual machine 31-1. According to the present embodiment, the packets transferred to the source server 2-1 during the above period may be prevented from being discarded.

In S34, the virtual switch 32-1 transfers a packet stored in the migration reception buffer included in the migration buffer 323-1 to the destination server 2-2 along with information (for example, a UUID or an MAC address) for identifying the virtual machine 31-1 to be migrated.

In S35, the virtual switch 32-1 determines whether the migration reception buffer included in the migration buffer 323-1 is empty. When the migration reception buffer included in the migration buffer 323-1 is not empty (“No” in S35), the virtual switch 32-1 returns the process to S34.

In S36, when the migration reception buffer included in the migration buffer 323-1 is empty (“Yes” in S35), the virtual switch 32-1 determines whether the source server 2-1 has received the migration completion notification from the destination server 2-2. When the source server 2-1 has not received the migration completion notification from the destination server 2-2 (“No” in S36), the virtual switch 32-1 returns the process to S35.

In S37, when the source server 2-1 has received the migration completion notification from the destination server 2-2 (“Yes” in S36), the virtual switch 32-1 determines whether the migration reception buffer is empty. When the migration reception buffer is not empty (“No” in S37), the virtual switch 32-1 returns the process to S34.

In S38, when the migration reception buffer is empty (“Yes” in S37), the virtual switch 32-1 transmits a transfer termination notification, which indicates that the transfer from the migration reception buffer is terminated, to the destination server 2-2 and deletes the migration reception buffer included in the migration buffer 323-1. The deletion of the migration reception buffer means that the entire stored contents of the migration reception buffer is deleted or that the migration reception buffer itself included in the migration buffer 323-1 is deleted. After S33 or S38, the virtual switch 32-1 terminates the process.

Upon detecting the termination of the virtual machine 31-1 during the migration of the virtual machine 31-1, the hypervisor in the source server 2-1 causes the CPU 21 to start the transfer of the stored contents of the migration transmission buffer and the migration reception buffer included in the migration buffer 323-1 to the destination server 2-2. Since no packet is newly stored in the migration transmission buffer created in the source server 2-1 because of the termination of the virtual machine 31-1, the source server 2-1 transmits the transfer termination notification, which indicates that the transfer from the migration transmission buffer is terminated, to the destination server 2-2 when the migration transmission buffer becomes empty.

Although the transfer of the stored contents of the migration reception buffer created in the source server 2-1 to the destination server 2-2 is also started, the source server 2-1 may receive a packet destined for the virtual machine 31-1 before the virtual machine 31-1 is restarted on the destination server 2-2 as the virtual machine 131-1 and the communication path on the network 3 is switched. In other words, a packet may be transmitted to the source server 2-1 before the network configuration is changed to update the communication path for the virtual machine 131-1 after the migration (that is, the migrated virtual machine 31-1) to the destination server 2-2. Accordingly, even after the migration reception buffer created in the source server 2-1 becomes empty, the transmission process is continued until the source server 2-1 receives the migration completion notification from the destination server 2-2 and the migration transmission buffer created in the source server 2-1 becomes empty. Finally, the source server 2-1 deletes both of the migration transmission buffer and the migration reception buffer.

The migration completion notification may be transmitted in accordance with, for example, generic attribute registration protocol (GARP).

FIG. 9 illustrates an exemplary functional configuration of a destination server according to the present embodiment. For convenience, it is assumed that the server 2-2 is the destination server. Referring to FIG. 9, the destination server 2-2 includes virtual machines 131-1 to 131-L (L is a natural number that is larger than or equal to one) and a virtual switch 32-2. That is, the server 2-2 runs the virtual machines 131-1 to 131-L. The hypervisor in the destination server 2-2 causes the CPU 21 of the server 2-2 to create and control each of the virtual machines 131-1 to 131-L and the virtual switch 32-2. The virtual switch 32-2 includes a selector 321-2, an ordinary buffer 322-2, a migration buffer 323-2, and a distributor 324-2. Switching software causes the CPU 21 to switch the packets. The selector 321-2 selectively outputs information from the virtual machines 131-1 to 131-L to the ordinary buffer 322-2 or the migration buffer 323-2. The distributor 324-2 selectively outputs information received over the network 3 to the ordinary buffer 322-2 or the migration buffer 323-2. The ordinary buffer 322-2 includes an ordinary reception buffer and an ordinary transmission buffer. The migration buffer 323-2 includes a migration reception buffer and a migration transmission buffer. Each of the ordinary buffer 322-2 and the migration buffer 323-2 is an input-output buffer including an input buffer (a reception buffer) and an output buffer (a transmission buffer).

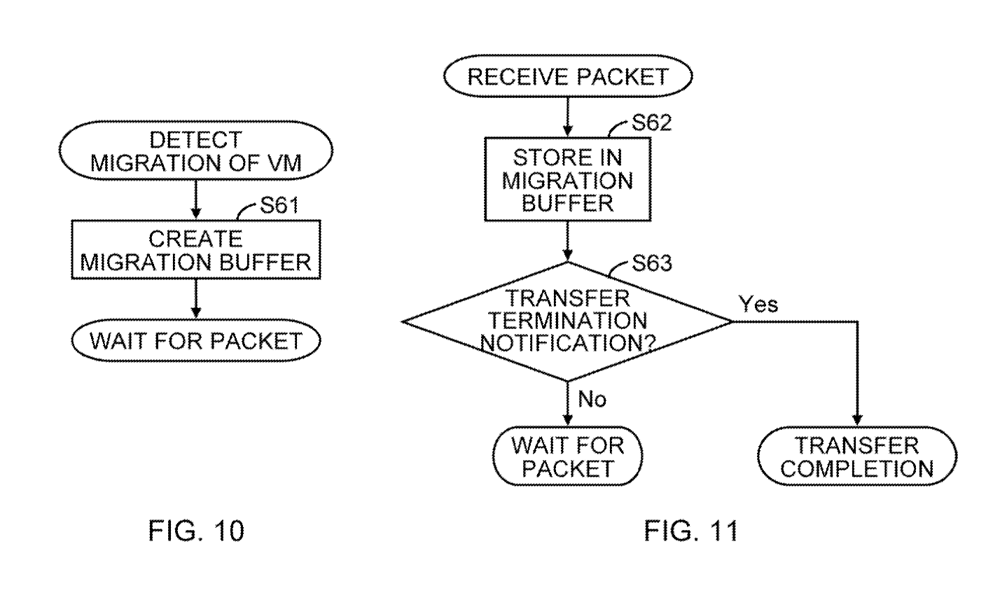

FIG. 10 illustrates an exemplary operation flow of the virtual switch 32-2 in the destination server 2-2 upon detecting the migration of the virtual machine 31-1 according to the present embodiment. The destination server 2-2 starts the operation flow illustrated in FIG. 10, upon detecting the migration of the virtual machine 31-1 by receiving information for identifying the virtual machine 31-1 to be migrated from the source server 2-1. Whether the virtual machine identified by the information for identifying the virtual machine is to be migrated may be learned on the basis of attribute information, which indicates that the virtual machine is to be migrated, attached to the information for identifying the virtual machine.

In S61, the hypervisor in the destination server 2-2 causes the CPU 21 to create the migration buffer 323-2 including the migration reception buffer and the migration transmission buffer in the storage unit 23 included in the destination server 2-2. As a result, the destination server 2-2 gets into a state of waiting for receiving a packet in which the destination server 2-2 waits for receiving a packet.

FIG. 11 illustrates an exemplary operation flow of the virtual switch 32-2 in the destination server 2-2 for receiving contents of the migration buffer 323-1 of the source server 2-1 according to the present embodiment. The virtual switch 32-2 performs the operation flow illustrated in FIG. 11 for each of the migration transmission buffer and the migration reception buffer. The virtual switch 32-2 starts the operation flow illustrated in FIG. 11 upon receiving a packet relating to the virtual machine 31-1 to be migrated.

In S62, the virtual switch 32-2 stores the received packet relating to the virtual machine 31-1 to be migrated in the migration buffer 323-2.

In S63, the virtual switch 32-2 determines whether the destination server 2-2 has received the transfer termination notification from an external server, that is, the source server 2-1 in this example. When the destination server 2-2 has not received the transfer termination notification from the source server 2-1 (“No” in S63), the destination server 2-2 gets into the state of waiting for receiving a packet. When the destination server 2-2 has received the transfer termination notification from the source server 2-1 (“Yes” in S63), the destination server 2-2 gets into a state of transfer completion in which the transfer, to the migration buffer 323-2, of packets relating to the virtual machine 31-1 to be migrated is completed.

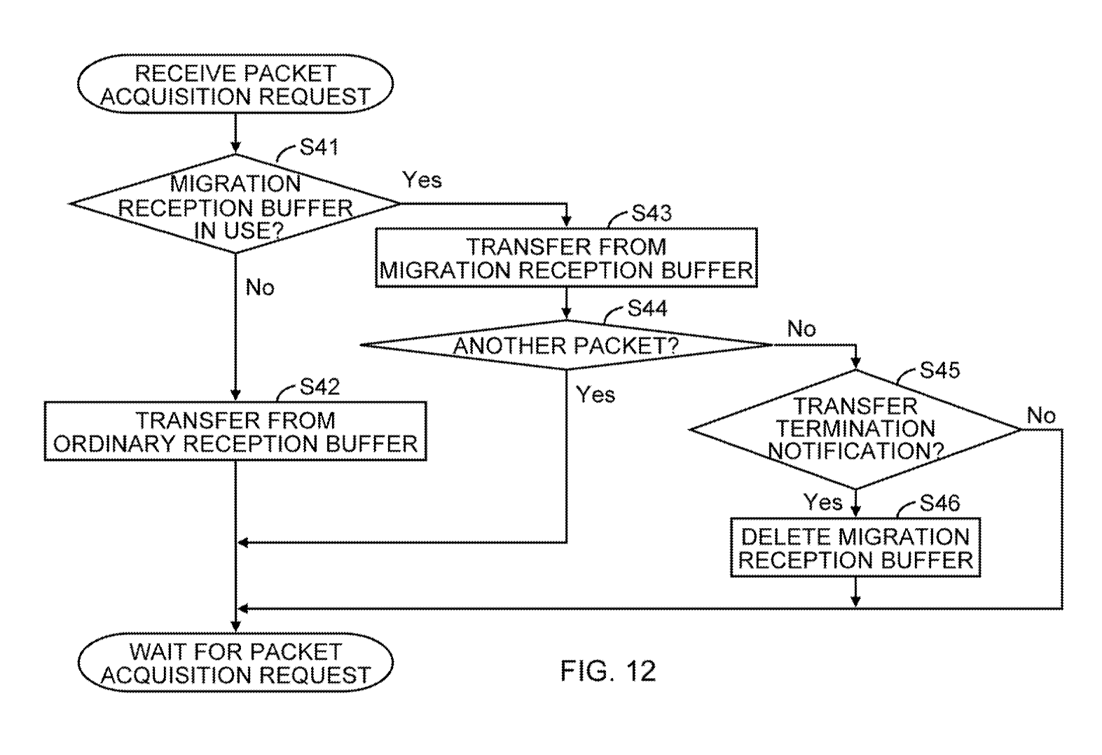

FIG. 12 illustrates an exemplary operation flow of the virtual switch 32-2 in the destination server 2-2 upon receiving a packet acquisition request from a virtual machine according to the present embodiment. The virtual switch 32-2 in the destination server 2-2 starts the operation flow illustrated in FIG. 12 upon receiving the packet acquisition request from any of the virtual machines 131-1 to 131-L in the destination server 2-2 after the virtual machine 31-1 is migrated to the destination server 2-2 and restarted as the virtual machine 131-1.

In S41, the virtual switch 32-2 determines whether the migration reception buffer included in the migration buffer 323-2 in the destination server 2-2 is in use.

In S42, when the migration reception buffer included in the migration buffer 323-2 created in the destination server 2-2 is not in use (“No” in S41), the virtual switch 32-2 acquires a packet stored in the ordinary reception buffer included in the ordinary buffer 322-2 and transfers the acquired packet to the request source VM.

In S43, when the migration reception buffer included in the migration buffer 323-2 in the destination server 2-2 is in use (“Yes” in S41), the virtual switch 32-2 acquires a packet stored in the migration reception buffer included in the migration buffer 323-2 and transfers the acquired packet to the request source VM.

In S44, the virtual switch 32-2 determines whether another packet destined for the request source VM is still stored in the migration reception buffer included in the migration buffer 323-2.

In S45, when no packet destined for the request source VM is stored in the migration reception buffer included in the migration buffer 323-2 (“No” in S44), the virtual switch 32-2 determines whether the destination server 2-2 has received the transfer termination notification indicating termination of the transfer to the migration reception buffer included in the migration buffer 323-2.

In S46, when the destination server 2-2 has received the transfer termination notification (“Yes” in S45), the virtual switch 32-2 deletes the migration reception buffer included in the migration buffer 323-2.

When a packet destined for the request source VM is still stored in the migration buffer 323-2 (“Yes” in S44), when the destination server 2-2 has not received the transfer termination notification (“No” in S45), after S42, or after S46, the virtual switch 32-2 gets into a state of waiting for receiving a packet acquisition request in which the virtual switch 32-2 waits for receiving a packet acquisition request from any of the virtual machines 131-1 to 131-L.

When the virtual machine 31-1 to be migrated is restarted as the virtual machine 131-1 in the destination server 2-2, the virtual switch 32-2 transfers a packet from the migration buffer 323-2 to the virtual machine 131-1 upon receiving a packet acquisition request from the virtual machine 131-1 if the migration reception buffer included in the migration buffer 323-2 is in use. When no packet exists in the migration reception buffer and the destination server 2-2 has received the transfer termination notification indicating termination of the transfer to the migration reception buffer, the destination server 2-2 determines that the migration reception buffer is not in use, and the destination server 2-2 deletes the migration reception buffer. When the migration reception buffer is not in use, the virtual switch 32-2 transfers a packet from the ordinary reception buffer included in the ordinary buffer 322-2 to the virtual machine 131-1.

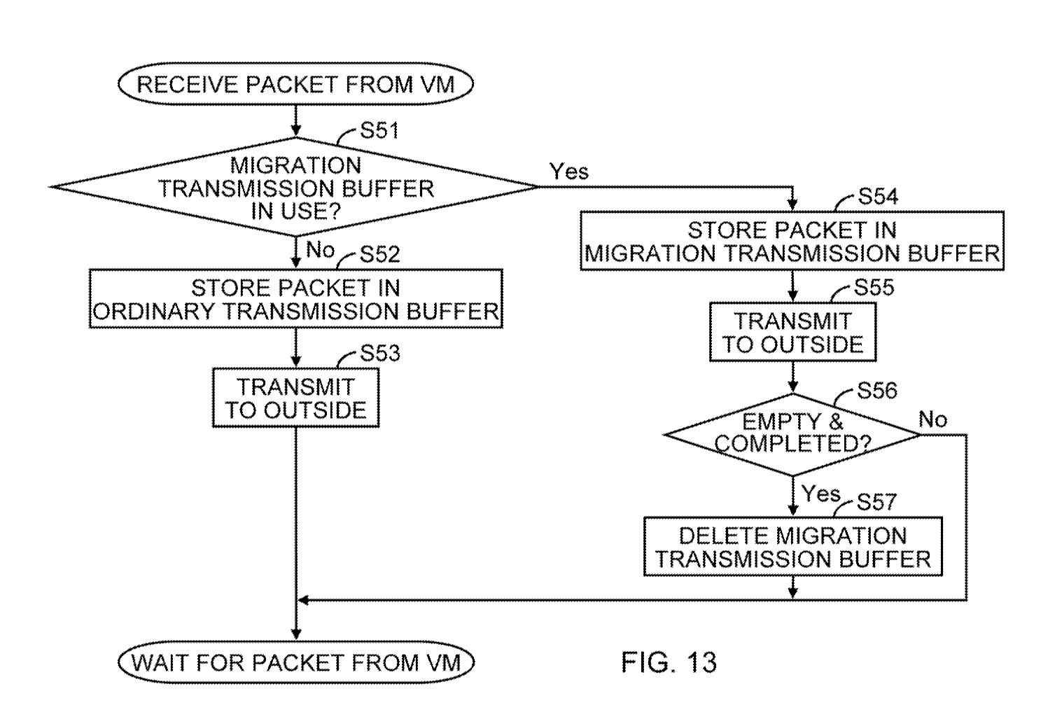

FIG. 13 illustrates an exemplary operation flow of the virtual switch 32-2 in the destination server 2-2 upon receiving a packet from a virtual machine according to the present embodiment. The virtual switch 32-2 starts the operation flow illustrated in FIG. 13 upon receiving a packet from any of the virtual machines 131-1 to 131-L in the destination server 2-2 after the virtual machine 31-1 is migrated to the destination server 2-2 and restarted as the virtual machine 131-1.

In S51, the virtual switch 32-2 determines whether the migration transmission buffer included in the migration buffer 323-2 in the destination server 2-2 is in use.

In S52, when the migration transmission buffer included in the migration buffer 323-2 in the destination server 2-2 is not in use (“No” in S51), the virtual switch 32-2 stores the packet received from, for example, the request source VM 131-1 in the ordinary transmission buffer included in the ordinary buffer 322-2.

In S53, the virtual switch 32-2 transmits the packet stored in the ordinary transmission buffer included in the ordinary buffer 322-2 to an external destination outside the destination server 2-2.

In S54, when the migration transmission buffer included in the migration buffer 323-2 in the destination server 2-2 is in use (“Yes” in S51), the virtual switch 32-2 stores the packet received from, for example, the request source VM 131-1 in the migration transmission buffer included in the migration buffer 323-2.

In S55, the virtual switch 32-2 transmits the packet stored in the migration transmission buffer included in the migration buffer 323-2 to an external destination outside the destination server 2-2.

In S56, the virtual switch 32-2 determines whether the migration transmission buffer included in the migration buffer 323-2 is empty and whether the server 2-2 has received a reception completion notification from the external destination.

In S57, when the migration transmission buffer included in the migration buffer 323-2 is empty and the server 2-2 has received the reception completion notification from the external destination (“Yes” in S56), the virtual switch 32-2 deletes the migration transmission buffer included in the migration buffer 323-2.

When the migration transmission buffer included in the migration buffer 323-2 is not empty or the migration buffer 323-2 is empty but the server 2-2 has not received the reception completion notification from the external destination (“No” in S56), after S53, or after S57, the destination server 2-2 gets into a state of waiting for receiving a packet in which the destination server 2-2 waits for receiving a packet from a virtual machine.

When the migration transmission buffer included in the migration buffer 323-2 is not in use, the destination server 2-2 stores a packet in the ordinary buffer 322-2 to transmit the packet to the outside of the destination server 2-2. However, when the migration transmission buffer included in the migration buffer 323-2 is in use, the destination server 2-2 stores a packet in the migration transmission buffer to transmit the packet to the outside of the destination server 2-2. When the migration transmission buffer included in the migration buffer 323-2 becomes empty after the transmission of the packet and the destination server 2-2 has received the reception completion notification, the destination server 2-2 determines that the migration transmission buffer is not in use, and is the destination server 2-2 deletes the migration transmission buffer.

As discussed above, according to the method of migrating a virtual machine in the present embodiment, the hypervisor in each server causes the CPU to create a migration buffer and perform the external communication of the virtual machine via the created migration buffer during the migration. Specifically, the hypervisor in each server causes the CPU to create a migration buffer for every virtual machine in response to the VM migration request. Each server stores, in the migration input buffer if available, information transmitted from an external machine to a virtual machine in the server, and in the ordinary input buffer if the migration input buffer does not exist. Upon receiving a packet acquisition request from a virtual machine, each server acquires the requested information from the migration input buffer if the requested information is not stored in the ordinary input buffer. In transmission of information from the virtual machine in each server to an external machine, each server stores the received information in the ordinary output buffer if the ordinary output buffer stores incomplete information to be transmitted. If no information to be transmitted from the virtual machine is stored in the ordinary output buffer, each server stores the received information in the migration output buffer and transmits the received information from the migration output buffer to the outside of the server.

When a server detects migration of a virtual machine, the hypervisor causes the CPU to create a dedicated migration buffer for the virtual machine that is being migrated, and set a use flag for the migration buffer to “in-use”. When the use flag is set to “in-use”, the communication with the virtual machine that is being migrated is performed via the migration buffer.

Upon detecting termination of the virtual machine being migrated, the source server starts to transfer the information stored in the migration buffer to the destination server along with the information (for example, the UUID or the MAC address) for identifying the virtual machine. When the migration buffer becomes empty, the source server transmits a transfer termination notification (or message) including the information for identifying the virtual machine to the destination server to notify the destination server of the completion of the migration of the virtual machine.

The source server determines that communication, which is destined for the virtual machine, transmitted to the source server has terminated when the source server receives the migration completion notification according to, for example, GARP from the destination server. The source server transmits the transfer termination notification when the migration input buffer created in the source server becomes empty.

When the virtual machine that is migrated in the destination server is restarted, communication by the virtual machine is restarted in the destination server. The destination server performs the communication via the migration buffer if the use flag for the migration buffer created in the destination server is set to “in-use” and via the ordinary buffer if the use flag is set to “not-in-use”. When incomplete information that is not transmitted yet is stored in the migration output buffer created in the destination server, the destination server creates a packet by adding information received from the restarted virtual machine to the incomplete information that is not transmitted yet and transmits the packet to the outside of the destination server. If the migration output buffer created in the destination server becomes empty after the transmission of the packet, the destination server sets the use flag for the migration output buffer to “not-in-use” to inhibit the use of the migration output buffer and thereafter transmits information received from the virtual machine via the ordinary buffer. Specifically, if no incomplete information that is not transmitted yet stored in the migration output buffer, the destination server sets the use flag for the migration output buffer to “not-in-use” to inhibit the use of the migration output buffer and thereafter transmits information received from the virtual machine via the ordinary buffer.

Upon receiving a packet acquisition request from a virtual machine, the destination server transfers information from the migration input buffer to the virtual machine if the use flag for the migration input buffer is set to “in-use” and from the ordinary input buffer if the use flag for the migration input buffer is set to “not-in-use”. The destination server sets the use flag for the migration input buffer to “not-in-use” when the destination server has received the transfer termination notification from the source server and the migration input buffer created in the destination server becomes empty. Thereafter, the destination server uses the ordinary input buffer.

Accordingly, it is possible to prevent packets received by the source server from being discarded during the migration of the virtual machine.

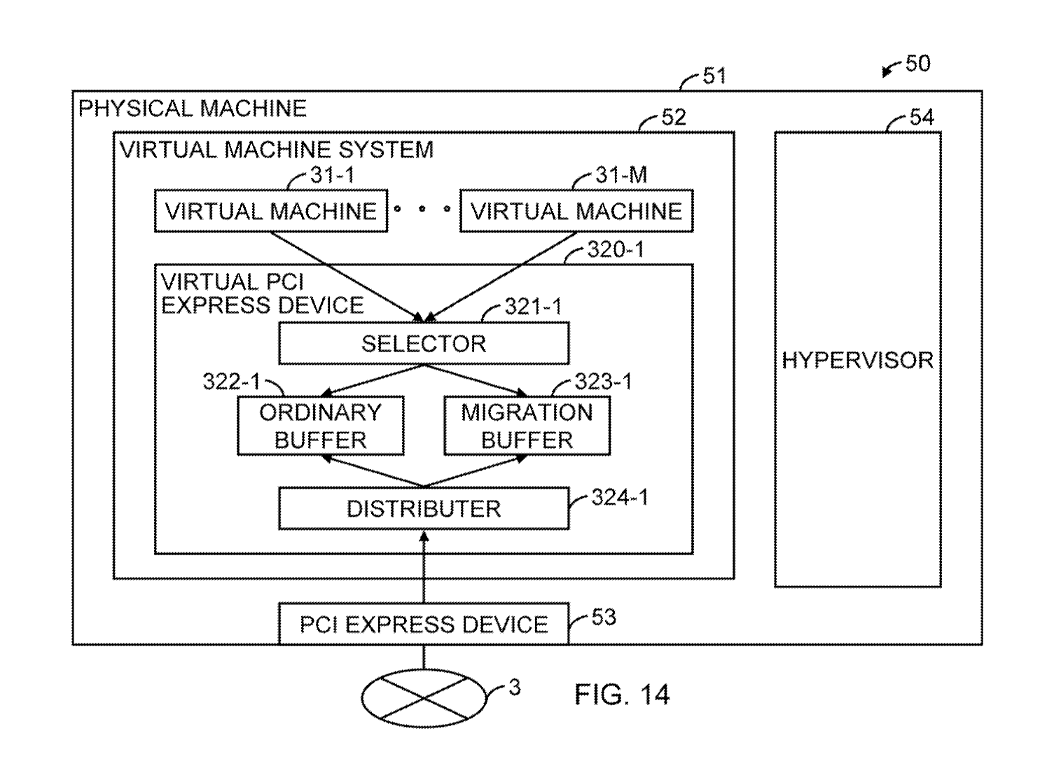

FIG. 14 illustrates exemplary access from a virtual machine to a peripheral component interconnect (PCI) Express device according to the present embodiment. Like reference numerals indicate like components illustrated in FIG. 3 and a discussion thereof is omitted herein. Referring to FIG. 14, a server 50 is composed of a physical machine 51, such as a general-purpose computer. The physical machine 51 includes a virtual machine system 52, a PCI Express device 53, and a hypervisor 54. The PCI Express device 53 is connected to, for example, the network 3 similar to the one illustrated in FIG. 1. The virtual machine system 52 includes virtual machines 31-1 to 31-M and a virtual PCI Express device 320-1.

In the example in FIG. 14, in access from each of the virtual machines 31-1 to 31-M to the PCI Express device 53, the hypervisor 54 in the server 50 causes the CPU of the physical machine 51 to create the virtual PCI Express device 320-1 corresponding to the PCI Express device 53. The functional configuration of the virtual PCI Express device 320-1 is similar to that of the virtual switch 32-1 illustrated in FIG. 3. The hypervisor 54 further causes the CPU to create the ordinary buffer 322-1 and the migration buffer 323-1 in the virtual PCI Express device 320-1. Upon detecting migration of any of the virtual machines 31-1 to 31-M, the virtual PCI Express device 320-1 uses the migration buffer 323-1, as in the example discussed with reference to FIG. 3.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been discussed in detail, it should be understood that the various changes, substitutions, and alterations could be made hereto without departing from the spirit and scope of the invention.

What is claimed is:

1. A method of migrating a virtual machine from a first computer to a second computer, the method comprising:
performing, by the first computer, an external communication of the virtual machine via a first buffer before starting migration of the virtual machine, while performing an external communication of the virtual machine via a second buffer different from the first buffer during the migration;
starting, by the first computer, the migration upon receiving a request for migrating the virtual machine;
storing, by the first computer, information destined for the virtual machine received during the migration in the second buffer; and
transferring the information stored in the second buffer from the first computer to the second computer in response to termination of the virtual machine.

2. The method according to claim 1, further comprising:
receiving, by the second computer, the information transferred from the first computer;
storing, by the second computer, the received information in a third buffer before a communication path for the virtual machine is updated; and
storing, by the second computer, the received information in a fourth buffer different from the third buffer after the communication path for the virtual machine is updated.

3. The method according to claim 1, further comprising:
transmitting a transfer termination notification from the first computer to the second computer when the second buffer is empty after receiving a migration completion notification from the second computer.

4. The method according to claim 1, further comprising:
transferring, by the first computer, the information stored in the second buffer to the virtual machine when the first buffer is empty in response to a request transmitted from the virtual machine for acquiring information destined for the virtual machine.

5. The method according to claim 1, further comprising:
creating, by the first computer, the second buffer by executing a hypervisor upon receiving the request for migrating the virtual machine.

6. A computer for running a virtual machine, the computer comprising:
a processor to execute a process, the process including:
performing an external communication of a first virtual machine via a first buffer before starting migration of the first virtual machine and performing an external communication of the first virtual machine via a second buffer different from the first buffer during the migration;
starting the migration upon receiving a request for migrating the first virtual machine;
storing first information destined for the first virtual machine received during the migration in the second buffer; and
transferring the first information stored in the second buffer to a destination computer in response to termination of the first virtual machine.

7. The computer according to claim 6, wherein
the processor further
receives second information destined for a second virtual machine;
stores the received second information in a third buffer before a communication path for the second virtual machine is updated; and
stores the received second information in a fourth buffer different from the third buffer after the communication path for the second virtual machine is updated.

8. The computer according to claim 6, wherein
the processor further
transmits a transfer termination notification to the destination computer when the second buffer is empty after receiving a migration completion notification from the destination computer.

9. The computer according to claim 6, wherein
the processor further
transfers the first information stored in the second buffer to the first virtual machine when the first buffer is empty in response to a request transmitted from the first virtual machine for acquiring information destined for the first virtual machine.

10. The computer according to claim 6, wherein
the processor further
creates the second buffer by executing a hypervisor upon receiving the request for migrating the first virtual machine.

11. A computer-readable, non-transitory medium storing a program that causes a computer to execute a procedure, the procedure comprising:
performing an external communication of a first virtual machine via a first buffer before starting migration of the first virtual machine and performing an external communication of the first virtual machine via a second buffer different from the first buffer during the migration;
starting the migration upon receiving a request for migrating the first virtual machine;
storing first information destined for the first virtual machine in the second buffer upon receiving the first information during the migration; and
transferring the first information stored in the second buffer to a destination computer in response to termination of the first virtual machine.

12. The computer-readable, non-transitory medium according to claim 11, wherein the program further causes the computer to execute:
receiving second information destined for a second virtual machine;
storing the received second information in a third buffer before a communication path for the second virtual machine is updated; and
storing the received second information in a fourth buffer different from the third buffer after the communication path for the second virtual machine is updated.

13. The computer-readable, non-transitory medium according to claim 11, wherein the program further causes the computer to execute:
transmitting a transfer termination notification to the destination computer when the second buffer is empty after receiving a migration completion notification from the destination computer.

14. The computer-readable, non-transitory medium according to claim 11, wherein the program further causes the computer to execute:
transferring the first information stored in the second buffer to the first virtual machine only when the first buffer is empty in response to a request transmitted from the first virtual machine for acquiring information destined for the first virtual machine.
